(19) United States
(12) Patent Application Publication
(10) Pub. No.: US 2025/0249553 A1
(43) Pub. Date: Aug. 7, 2025

(54) Micro-motion Open-ended Wrench

(71) Applicants: Yang-Hua Lee, Changhua City (TW); Shaodong Zhang, Zhangjiagang City (CN)

(72) Inventors: CHIA-HSUAN LEE, Changhua City (TW); Kai Zhang, Zhangjiagang City (CN)

(21) Appl. No.: 18/617,631

(22) Filed: Mar. 26, 2024

(30) Foreign Application Priority Data
Feb. 7, 2024 (TW) 113104996

(51) Int. Cl. B25B 13/46

(52) U.S. Cl. CPC B25B 13/46

(57) ABSTRACT

The present invention provides a micro-motion open-ended wrench, wherein a actuating block is arranged in a chute of a head seat for displacement in the first to second positions. The actuating block maintains the first position by a spring. A clockwise claw has a front drive portion and a rear drive portion arranged thereon. The actuating block has a first jaw and a second jaw disposed in the opening. When the actuating block is in the first position, the first jaw and the front drive portion can be engaged with the wrench part. When the handle is returned idly in the reverse direction, the actuating block can be moved to the second position to switch the second jaw and the rear drive portion to engage the wrench part, and the screw workpiece is driven to rotate in the clockwise direction by alternating force to reduce the reverse idling return angle.

### BACKGROUND OF THE PRESENT INVENTION

### Field of Invention

The present invention is a micro-motion open-ended wrench that can exert force to drive the screw workpiece to rotate in the forward direction and empty return the screw workpiece in the reverse direction, especially the technology that can effectively reduce the reverse idling return angle.

### Description of Related Arts

U.S. Invention Publication US20090301271A1 “Ratchetable open-ended wrench” discloses an open-end wrench that can apply force to drive the screw workpiece to rotate in the clockwise direction and to empty return the screw workpiece in the reverse direction. In the prior art, when the wrench is used with general screw workpiece that mostly have a hexagonal head, dividing 360° by 6 gives an angle of 60 degrees for the side-changing angle on each side of the wrench. This 60-degree angle is the reverse idling return angle of wrench. However, when used in the operation of narrow environments, there are operational inefficiencies, and it cannot be used in certain special situations. Therefore, there is a need for redesigning.

### SUMMARY OF THE PRESENT INVENTION

The present invention provides a micro-motion open-ended wrench that can improve the shortcomings of the prior art. The special features are:
1. The head seat is slidably equipped with an actuating block, and the actuating block is equipped with a first jaw and a second jaw that can alternately move differentially in the opening.
2. The present invention is provided with a front drive portion and a rear drive portion in the clockwise claw.
3. The present invention controls the actuating block to maintain the first position, so that the first jaw and the front drive portion can be engaged with the wrench part of the screw workpiece. However, when the handle is returned idly and reversely to move the actuating block to the second position, the second jaw and the rear drive portion can be switched to engage the wrench part.

Accordingly, every time the handle returns idly in the reverse direction, it can link the actuating block to switch to the first position or the second position, so that it can alternately apply force to drive the screw workpiece to rotate in the clockwise direction when used in conjunction with the front drive portion or the rear drive portion. In this way, the reverse idling return angle can be effectively reduced, greatly increasing the operating efficiency and versatility of use.

### BRIEF DESCRIPTION OF THE DRAWINGS

FIG. 1 is an exploded view of the present invention.

FIG. 2 is an enlarged view of the actuating block of the present invention.

FIG. 3 is an assembled perspective view of FIG. 1.

FIG. 4 is a perspective view of the open-end wrench of the present invention embedded in the first and fourth sides of the screw workpiece.

FIG. 5 is a sectional view of the screw workpiece driven by the open-end wrench of the present invention to rotate in the clockwise direction.

FIG. 6 is a sectional view of the first movement of the reverse idling return of the open-end wrench of the present invention.

FIG. 7 is a sectional view of the second movement of the reverse idling return of the open-end wrench of the present invention.

FIG. 8 is a sectional view of the present invention when the actuating block is displaced to the second position.

FIG. 9 is a sectional view of the operation of loosening the screw workpiece after the actuating block of the present invention is in the second position and drives the screw workpiece to rotate in the clockwise direction to a fixed point.

### DETAILED DESCRIPTION OF THE PREFERRED EMBODIMENT

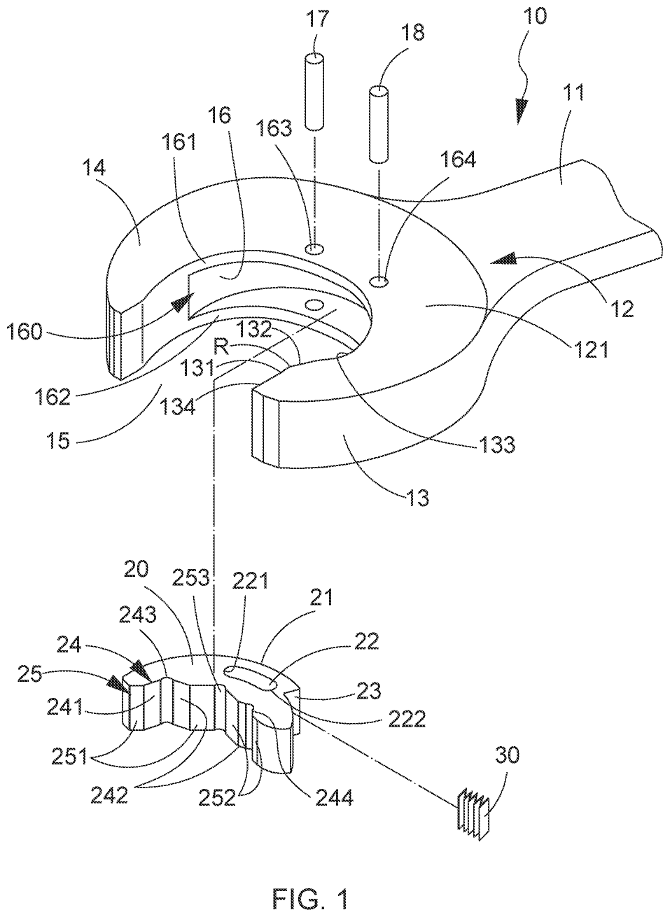

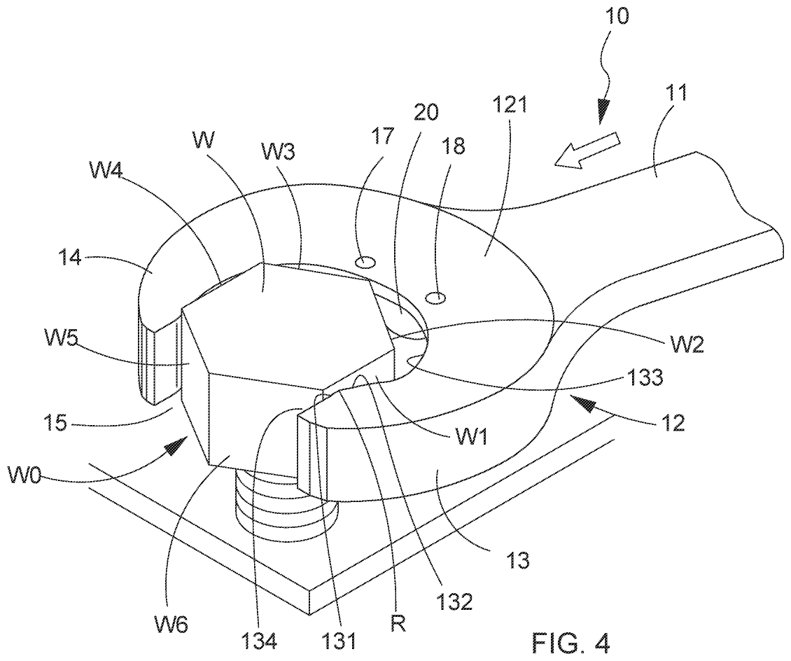

Referring to FIGS. 1 to 9, the present invention is an open-ended wrench that can drive the screw workpiece (W) to rotate in the clockwise direction and return idly the screw workpiece (W) in the counterclockwise direction, and includes a body (10), an actuating block (20), and a spring (30), respectively, arranged thereon.

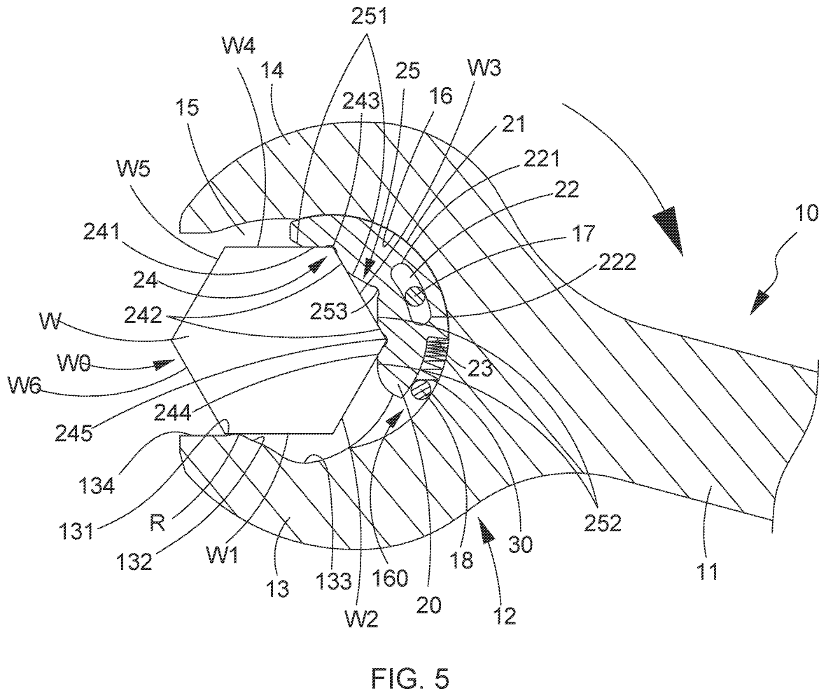

As shown in FIGS. 1 to 5, the body (10) has a handle (11), a head seat (12) located at the front end of the handle (11), a clockwise claw (13) and a counterclockwise claw (14) extending forward from the head seat (12), a throat portion (121) formed between the rear end of the clockwise claw (13) and the rear end of the counterclockwise claw (14) on the head base (12), and an opening (15) formed by a space surrounded by the defining throat portion (121), clockwise claw (13) and counterclockwise claw (14), which is capable of being used for the entry and exit of the wrench part (W0) of the screw workpiece (W), wherein the wrench part (W0) is a regular hexagon, and is defined in reverse order from the six o'clock position as shown in FIG. 5 as the first side (W1), second side (W2), third side (W3), fourth side (W4), fifth side (W5), and sixth side (W6), wherein the clockwise claw (13) has a front drive portion (131) formed on the wall of the opening (15) for the wrench part (W0) to fit into, a rear drive portion (132) formed behind the front drive portion (131), an avoidance area (133) recessed behind the rear drive portion (132), and an outer slope (134) extended forward from the front end of the front drive portion (131) to gradually expand the opening (15) to facilitate the accurate embedding of the wrench part (W0) into the front drive portion (131), wherein the avoidance area (133) is used to prevent the wrench part (W0) from interfering when the rear drive portion (132) is engaged and disengaged, wherein the rear drive portion (132) and the front drive portion (131) are arranged in non-same planes, so that the intersection of the two forms an arc angle (R).

An arc-shaped rail surface (16) is provided in the throat portion (121) of the head seat (12), wherein a chute (160) communicated between the rail surface (16) and the opening (15), wherein the reverse ends of the rail surface (16) and the chute (160) are connected to the counterclockwise claw (14), wherein an upper wall (161) and a lower wall (162) are formed correspondingly to the top surface and bottom surface of the chute (160), wherein a first hole (163) and a second hole (164) are provided through the upper wall (161) and the lower wall (162) to correspond to a guide post (17) and an upright post (18) being longitudinally fixed in the chute (160), wherein the guide post (17) is located between the counterclockwise claw (14) and the upright post (18), wherein the rail surface (16) and chute (160) can be made by entering the opening (15) through a T-shaped milling cutter, and then cutting along the radial direction of the opening (15) toward the throat portion (121).

The actuating block (20) is a sliding combination with the chute (160), which is made of powder metallurgy and has a pressing surface (21) that matches the curvature of the rail surface (16). In addition, the actuating block (20) has a guide groove (22) for the guide post (17) to penetrate. The guide groove (22) is curved, with a curvature consistent with the curvature of the rail surface (16), and has a closed counterclockwise end (221) and a clockwise end (222). When the pressing surface (21) slides along the rail surface (16) in a large area, the guide post (17) can restrict the actuating block (20) from coming out of the chute (160), so that the actuating block (20) can be displaced between a first position and a second position.

The actuating block (20) has a shoulder (23) recessed at the forward end of the pressing surface (21), so that an area for the spring (30) to be installed is formed between the shoulder (23) and the upright post (18), so that the spring (30) can provide a reverse pre-pressure force to the actuating block (20) to urge the actuating block (20) to maintain the first position. At this time, the guide post (17) is located in the middle of the counterclockwise end (221) and the clockwise end (222) of the guide groove (22), so as to provide the actuating block (20) with a margin for forward or reverse displacement, so that the actuating block (20) can be displaced back and forth between the first position and the second position.

The actuating block (20) has a first jaw (24) and a second jaw (25) disposed in the opening (15) for alternately differentially driving the wrench part (W0) to spin in the clockwise direction.

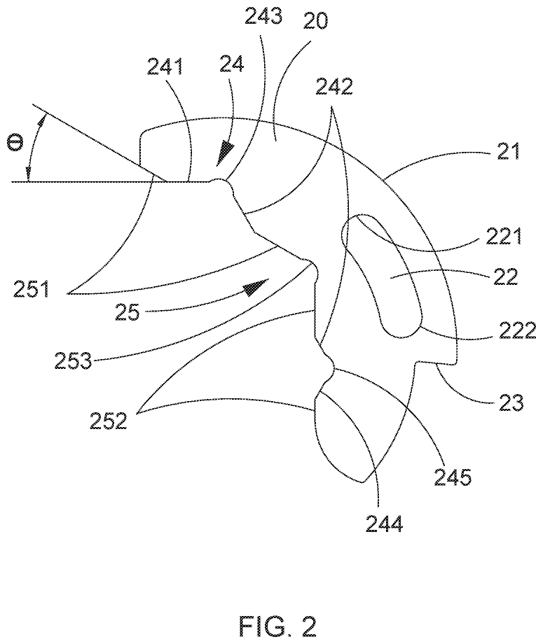

As shown in FIGS. 2 and 5, the first jaw (24) includes a first surface (241), a second surface (242), a first angular groove (243), a third surface (244) and a second angular groove (245) respectively provided thereon. The first surface (241) is located on the front edge of the actuating block (20) adjacent to the counterclockwise claw (14). When the actuating block (20) is in the first position, the first surface (241) is opposite to the front drive portion (131), which is used for the fourth side (W4) and the first side (W1) parallel to the wrench part (W0) to be correspondingly embedded. The rear end of this first surface (241) is provided with the second surface (242) for the third side (W3) of the wrench part (W0) to couple. A 120-degree angle is formed between the first surface (241) and the second surface (242), and the first angular groove (243) is recessed at the intersection of the two surfaces. The rear end of the second surface (242) is additionally provided with a third surface (244) for the second side (W2) of the wrench part (W0) to couple. A 120-degree angle is formed between the second surface (242) and the third surface (244), and the second angular groove (245) is recessed at the intersection of the two surfaces. The first angular groove (243) and the second angular groove (245) are used to accommodate corresponding corners of the wrench part (W0), so that the first jaw (24) can engage the wrench part (W0) in a large area. When the handle (11) drives the head seat (12) in the clockwise direction, it can act on the front drive portion (131) and the first jaw (24) to apply force to drive the screw workpiece (W) to rotate in the clockwise direction, causing the screw workpiece (W) to perform locking work.

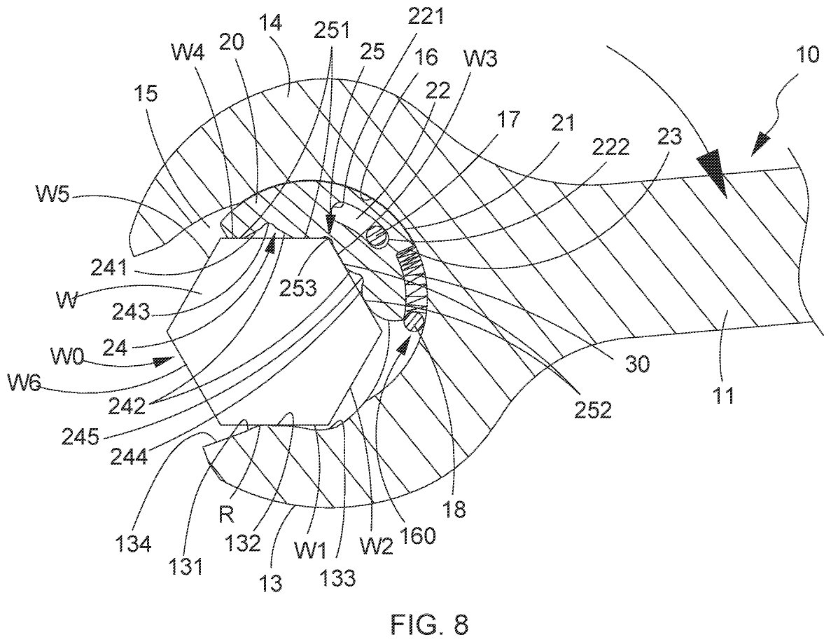

The second jaw (25) includes a fourth surface (251), a fifth surface (252) and a third angular groove (253) respectively provided thereon. The fourth surface (251) spans the front and rear ends of the first surface (241), referring to FIG. 8, when the actuating block (20) is in the second position, the fourth surface (251) is opposite to the rear drive portion (132), which is used for the fourth side (W4) and the first side (W1) parallel to the wrench part (W0) to be correspondingly embedded, so that the rear drive portion (132) and the second jaw (25) can replace the front drive portion (131) and the first jaw (24), and then apply differential force to drive the screw workpiece (W) to rotate in the clockwise direction. Therefore, the intersection of the fourth surface (251) and the first surface (241) has a differential angle (0). The differential angle (0) is the reverse idling return angle of the first jaw (24) and the second jaw (25) alternately differential the wrench part (W0). This differential angle (0) is capable of being controlled between 20 degrees and 40 degrees, which is much smaller than the 60 degrees disclosed in the previous patent, which is quite conducive to operations in narrow spaces. In terms of specific implementation, this fourth surface (251) has a front section and a rear section, wherein the front section is connected forward from the front end of the first surface (241), and the rear section is beveled and recessed in the middle section of the second surface (242). The fifth surface (252) spans both ends of the third surface (244) and has a first section and a second section, wherein the first section is connected to the rear end of the fourth surface (251), and the second section is connected to the outer end of the third surface (244). A 120-degree angle is formed between the fifth surface (252) and the fourth surface (251), and the third angular groove (253) is recessed at the intersection of the two surfaces to accommodate corresponding corners of the wrench part (W0), in order to facilitate the second jaw (25) to cooperate with the rear drive portion (132) and engage the wrench part (W0), so that it can exert enough force to drive the screw workpiece (W) to rotate in the clockwise direction.

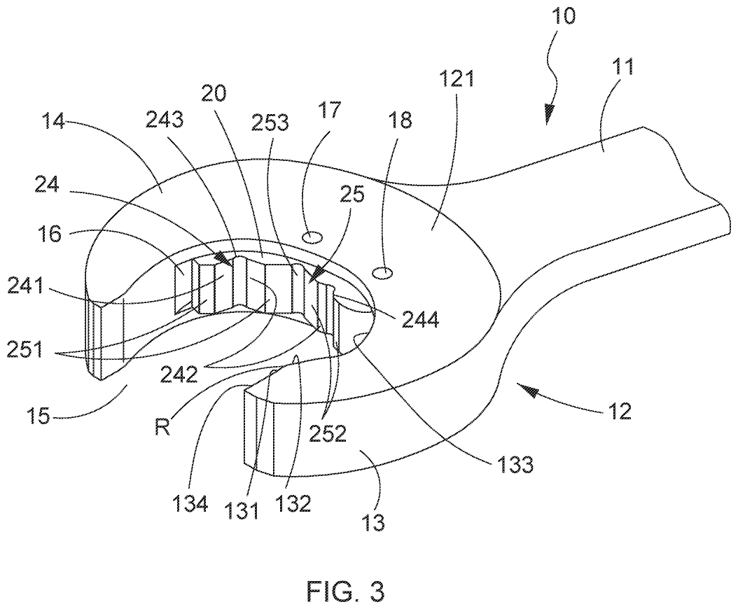

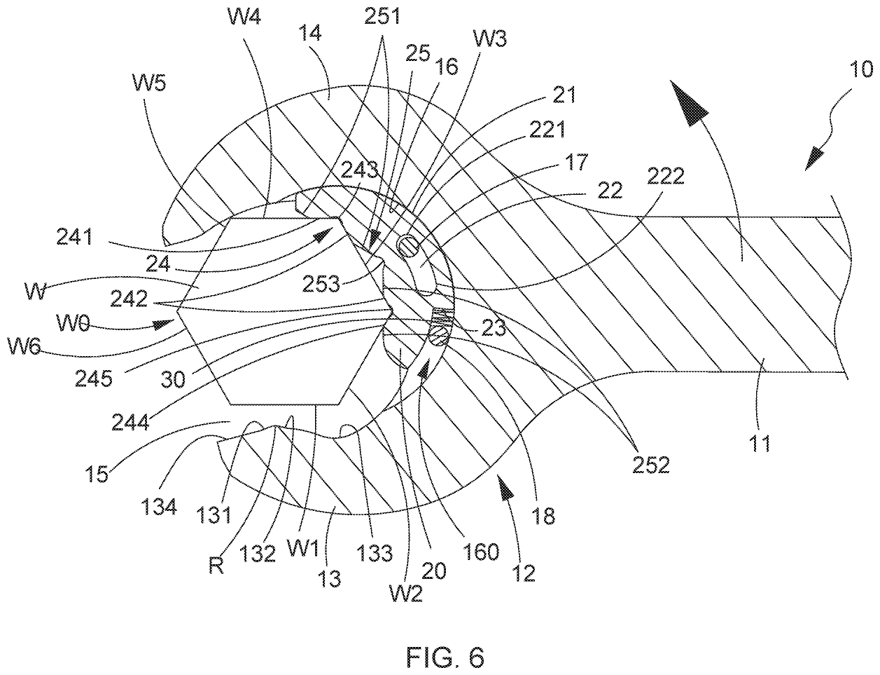

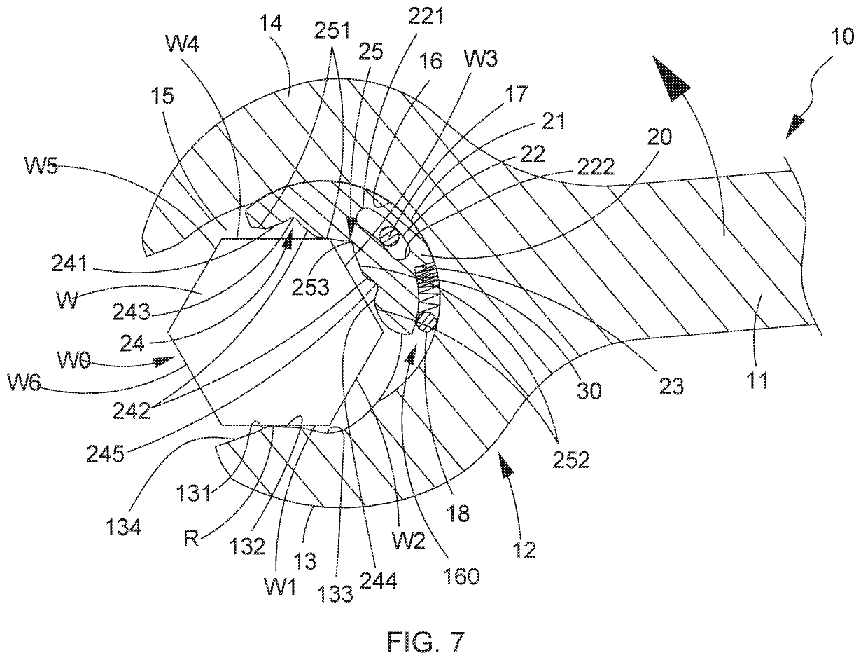

In the present invention, the spring (30) can urge the actuating block (20) to remain in the first position. As shown in FIGS. 3 to 5, the first jaw (24) and the front drive portion (131) are usually in a state where the wrench part (W0) can be directly engaged with each other, so as to facilitate the locking work by applying force to drive the screw workpiece (W) to spin in the clockwise direction. When the limited working environment or personal habits are not easy to continue to exert force, the handle (11) can be reversed and returned as shown in FIG. 6, the first jaw (24) engages the wrench part (W0), the actuating block (20) can have enough margin to move clockwise to overcome the spring (30), prompting the front drive portion (131) to separate from the wrench part (W0). Then, as shown in FIG. 7, the first jaw (24) is separated from the wrench part (W0), and the actuating block (20) is displaced counterclockwise to the second position as shown in FIG. 8. Referring to FIGS. 5 to 8, the handle (11) can complete a reverse idling return between degrees and 40 degrees to enable the first jaw (24) and the front drive portion (131) to release the wrench part (W0), and then switch to the state where the second jaw (25) and the rear drive portion (132) are correspondingly embedded in the wrench part (W0). The reverse idling return angle of the present invention can be effectively reduced compared to the previous technology, which can greatly improve the operating efficiency of the reciprocating force to drive the screw workpiece (W) to rotate clockwise, and is widely applicable to some special narrow environments. In the same way, when the user can no longer continue to apply force on the handle (11), the handle (11) only needs to idle reversely for about 20 to 40 degrees, thereby activating the second jaw (25) and the rear drive portion (132) to release the wrench part (W0), and then switching to the state where the first jaw (24) and the front drive portion (131) engage the wrench part (W0). Therefore, the overall configuration of the first jaw (24), second jaw (25), front drive portion (131), and rear drive portion (132) of the present invention can effectively reduce the reverse idling return angle of the handle (11), providing users with more satisfactory operation.

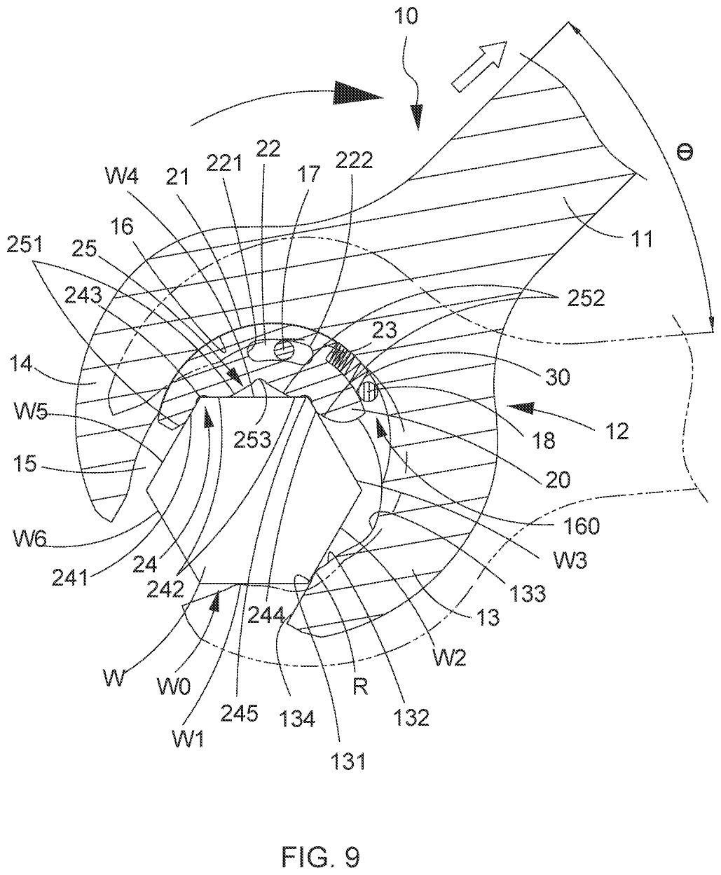

FIG. 9 shows that when the actuating block (20) is in the second position shown in FIG. 8, if the wrench part (W0) is disengaged from the opening (15), it needs to operate the handle (11) to idle reversely a differential angle (e), that is, the actuating block (20) is moved to the first position, so that the first jaw (24) and the front drive portion (131) fit into the wrench part (W0), and the wrench part (W0) is released from the opening (15).

The above is only one of the preferred embodiments of the present invention and should not be used to limit the implementation scope of the present invention; that is, all equivalent changes and modifications made according to the claims of the present invention belong to the present invention.

What is claimed is:

1. A micro-motion open-ended wrench, which at least comprises:
a body, having a handle, a head seat located at the front end of the handle, a clockwise claw and a counterclockwise claw extending forward from the head seat, and an opening formed by the defining the head seat, the clockwise claw and the counterclockwise claw, wherein the opening is capable of being used for the entry and exit of the wrench part of the screw workpiece, wherein the clockwise claw has a front drive portion and a rear drive portion formed on a wall of the opening, wherein the rear drive portion is located behind the front drive portion and is arranged in non-same plane, wherein an arc-shaped rail surface is provided in the head seat, wherein a chute communicated between the rail surface and the opening, wherein a guide post is fixed longitudinally in the chute;
an actuating block, which is a sliding combination with the chute, has a pressing surface matching the rail surface, and a guide groove for the guide post to penetrate, so that when the pressing surface slides along the rail surface, the actuating block is capable of being displaced from a first position to a second position, wherein the actuating block has a first jaw and a second jaw, respectively, disposed in the opening; and
a spring, provided in the chute, provides reverse pre-pressure to the actuating block, so that the actuating block maintains the first position, and urges the first jaw and the front drive portion to engage the wrench part to drive the screw workpiece to rotate in the clockwise direction, wherein when the handle idles reversely and pushes the actuating block to the second position, the first jaw and the front drive portion will release the wrench part, and then switch to the second jaw and the rear drive portion to embed with the wrench part, so as to alternately apply force to drive the screw workpiece to rotate in the clockwise direction.

2. The micro-motion open-ended wrench, as recited in claim 1, wherein the first jaw has a first surface located on the actuating block, when the actuating block is in the first position, the first surface and the front drive portion are capable of being engaged with the wrench part, wherein the second jaw has a fourth surface located on the actuating block, when the actuating block is in the second position, the fourth surface and the rear drive portion are capable of being engaged with the wrench part, wherein the fourth surface intersects the first surface with a differential angle, and the differential angle is controlled between 20 degrees and 40 degrees.

3. The micro-motion open-ended wrench, as recited in claim 2, wherein an arc angle is formed at the intersection of the rear drive portion and the front drive portion.

4. The micro-motion open-ended wrench, as recited in claim 2, wherein the first surface is located at the front edge of the actuating block adjacent to the counterclockwise claw, wherein the first jaw has a second surface connected with the rear end of the first surface, wherein the first surface and the second surface form an included angle of 120 degrees, wherein a first angular groove is recessed at the intersection of the first surface and the second surface, wherein a fifth surface is connected with the rear end of the fourth surface, wherein the fifth surface and the fourth surface form an angle of 120 degrees, wherein a third angular groove is recessed at the intersection of the fifth surface and the fourth surface.

5. The micro-motion open-ended wrench, as recited in claim 4, wherein the first jaw has a third surface connected with the rear end of the second surface, wherein the third surface and the second surface form an angle of 120 degrees, wherein a second angular groove is recessed at the intersection between the third surface and the second surface.

6. The micro-motion open-ended wrench, as recited in claim 5, wherein the fourth surface spans the front and rear ends of the first surface and has a front section and a rear section, wherein the front section is extended forward from the front end of the first surface, and the rear section is beveled and recessed in the middle section of the second surface, wherein the fifth side spans both ends of the third surface and has a first section and a second section, wherein the first section is connected to the rear end of the fourth surface, and the second section is connected to the outer end of the third surface.

7. The micro-motion open-ended wrench, as recited in claim 1, wherein the clockwise claw has an avoidance area recessed on the wall surface thereof behind the front drive portion.

8. The micro-motion open-ended wrench, as recited in claim 2, wherein the clockwise claw has an avoidance area recessed on the wall surface thereof behind the front drive portion.

9. The micro-motion open-ended wrench, as recited in claim 3, wherein the clockwise claw has an avoidance area recessed on the wall surface thereof behind the front drive portion.

10. The micro-motion open-ended wrench, as recited in claim 4, wherein the clockwise claw has an avoidance area recessed on the wall surface thereof behind the front drive portion.

11. The micro-motion open-ended wrench, as recited in claim 5, wherein the clockwise claw has an avoidance area recessed on the wall surface thereof behind the front drive portion.

12. The micro-motion open-ended wrench, as recited in claim 1, wherein the head seat has a upright post fixed longitudinally in the chute, wherein the guide post is located between the counterclockwise claw and the upright post, wherein the actuating block has a shoulder recessed at the forward end of the pressing surface, so that an area for the spring to be installed is formed between the shoulder and the upright post.

13. The micro-motion open-ended wrench, as recited in claim 2, wherein the head seat has a upright post fixed longitudinally in the chute, wherein the guide post is located between the counterclockwise claw and the upright post, wherein the actuating block has a shoulder recessed at the forward end of the pressing surface, so that an area for the spring to be installed is formed between the shoulder and the upright post.

14. The micro-motion open-ended wrench, as recited in claim 3, wherein the head seat has a upright post fixed longitudinally in the chute, wherein the guide post is located between the counterclockwise claw and the upright post, wherein the actuating block has a shoulder recessed at the forward end of the pressing surface, so that an area for the spring to be installed is formed between the shoulder and the upright post.

15. The micro-motion open-ended wrench, as recited in claim 4, wherein the head seat has a upright post fixed longitudinally in the chute, wherein the guide post is located between the counterclockwise claw and the upright post, wherein the actuating block has a shoulder recessed at the forward end of the pressing surface, so that an area for the spring to be installed is formed between the shoulder and the upright post.

16. The micro-motion open-ended wrench, as recited in claim 5, wherein the head seat has a upright post fixed longitudinally in the chute, wherein the guide post is located between the counterclockwise claw and the upright post, wherein the actuating block has a shoulder recessed at the forward end of the pressing surface, so that an area for the spring to be installed is formed between the shoulder and the upright post.

17. The micro-motion open-ended wrench, as recited in claim 1, wherein the pressing surface matches the curvature of the rail surface, wherein the guide groove is curved and consistent with the curvature of the rail surface, wherein the guide groove has a closed counterclockwise end and a clockwise end, wherein when the actuating block is maintained in the first position, the guide post is located at the middle position between the counterclockwise end and the clockwise end.

18. The micro-motion open-ended wrench, as recited in claim 2, wherein the pressing surface matches the curvature of the rail surface, wherein the guide groove is curved and consistent with the curvature of the rail surface, wherein the guide groove has a closed counterclockwise end and a clockwise end, wherein when the actuating block is maintained in the first position, the guide post is located at the middle position between the counterclockwise end and the clockwise end.

19. The micro-motion open-ended wrench, as recited in claim 3, wherein the pressing surface matches the curvature of the rail surface, wherein the guide groove is curved and consistent with the curvature of the rail surface, wherein the guide groove has a closed counterclockwise end and a clockwise end, wherein when the actuating block is maintained in the first position, the guide post is located at the middle position between the counterclockwise end and the clockwise end.

20. The micro-motion open-ended wrench, as recited in claim 4, wherein the pressing surface matches the curvature of the rail surface, wherein the guide groove is curved and consistent with the curvature of the rail surface, wherein the guide groove has a closed counterclockwise end and a clockwise end, wherein when the actuating block is maintained in the first position, the guide post is located at the middle position between the counterclockwise end and the clockwise end.
